(19) United States
(12) Patent Application Publication
(10) Pub. No.: US 2017/0316674 A1
(43) Pub. Date: Nov. 2, 2017

(54) DIGITAL COMMAND PROMPTING DEVICE

(71) Applicants: KATRINA GOFF CANDY, Echuca (AU); Ian Victor Chaffey, Tongala (AU)

(72) Inventors: KATRINA GOFF CANDY, Echuca (AU); Ian Victor Chaffey, Tongala (AU)

(21) Appl. No.: 15/256,503

(22) Filed: Sep. 2, 2016

(30) Foreign Application Priority Data
May 2, 2016 (AU) 2016901595

(51) Int. Cl. G08B 21/24; G06F 3/01; G08B 25/10; G01S 19/14; G08B 3/10; G06F 3/16; G08B 6/00; G08B 25/01; H04W 4/00; H04B 1/3827

(52) U.S. Cl. CPC G08B 21/24; G08B 6/00; G06F 3/016; G08B 25/10; G08B 25/016; G01S 19/14; G08B 3/1025; G06F 3/167; H04B 2001/3855; H04W 4/008

(57) ABSTRACT

The Digital Command Prompting Device is an aid is to help all people, especially those who have special needs particularly individuals who have diminished or diminishing function of their brain. The device is predominately mobile but can also be stationary and can be programmed by receiving and selecting pre-set commands to operate and assist a User with their daily living standards or needs. The device also has other various features including an illuminated display panel, a GPS tracking capability, an alarm, an illumination element, solar panel and battery backup components, time and date clocks, is provided water resistance covers and/or material, among other things. The device may be used within the home environment, outdoor environment or a restricted environment, e.g. aged care facility, hospital, pre-school or school.

### CROSS-REFERENCE TO RELATED APPLICATIONS

This application is a continuation-in-part of provisional Australian patent application no. 2016901595 filed May 2, 2016.

### FEDERALLY SPONSORED RESEARCH AND DEVELOPMENT

None.

### APPENDICES

None.

### SUMMARY OF THE INVENTION AND PRIOR ART

There exists in the prior art medical alert devices used to assist people, usually elderly or disabled, which act to contact or communicate with emergency medical facilities in the event a person has a traumatic medical event. This event may be a fall where the person is unable to right themselves, or when they have a stroke or heart attack disabling them from verbally calling for help. These medical alert devices usually consist of a small device attached to a lanyard or other cord necklace to allow the device to worn by a User and the device usually has a single button to be pushed by the User. The button can then activate a communication component for directing connecting with emergency medical facilities. These medical alert devices however are usually a single function apparatus and usually lack any other capabilities for assisting a User.

These is a need for a device which has the capability both to act as a medical alert device but additionally can be used to assist a person through their entire daily and nightly routines by prompting them at the appropriate time to perform certain tasks. There is a particular need for individuals of diminished mental or brain function, either because of being of young age, for example, a pre-schooler or for elderly individuals whose mental or brain function is diminishing because of age; the device is further capable of being used by visually or hearing impaired, handicapped or mute individuals The device is further provided with an alarm feature in the form of a prompt, for example, a vibrator or sounder which signals the User to perform a certain task; the device continues to repeat to vibrate or sound an alarm to get the attention of the User. If after a certain time frame there is no response from the User, the device switches over to a medical alert signal which is transmitted to a medical alert staff desk, nursing station or emergency office or facility.

The instant invention comprises a digital command prompting device, hereinafter “DCP device”, and system to assist and help people with medical needs and assistance, such as elderly or ailing people, hereinafter “a User”. The DCP device is especially constructed for those people who have special medical needs, such as those with Alzheimer's disease, dementia, or similar age related conditions. The DCP device is further constructed to be programmed by receiving and selecting pre-set commands to operate and assist a User to help them with all aspects of their daily living.

The DCP device is further constructed to either be mobile or stationary and may come in various applications, e.g, such as a cord necklace, or lanyard fitted DCP device, to be worn by the User. The DCP device is also constructed to be fitted to a wrist bracelet or watch band which is water resistant such that it can be worn in any environment including a shower, bath, rehabilitation pool, etc.

As previously stated, the DCP device could be stationary and sited beside their bed or it could be an electronic mobile device with a computer application for operating the DCP device and system. The DCP device can also be fitted to an automobile and although the DCP device is primarily constructed for a User with special medical needs, it can also be used for a functional but forgetful User. And depending on the degree of the diminishing thought process of a User, which may vary due to their capacity during the day and may cause them to become tied or confused the commands of the DCP device may increase. This diminished capacity often occurs at the end of the day.

The DCP device is also capable of being programmed to accommodate any type of physical or mental User disability and is constructed with have daily-calendar as a reminder for the User, e.g., to collect their newspaper or weekly calendar reminder, e.g., Tuesday garbage put the bins out on street

The DCP device can also inform the User of the activities that are available in the nursing home or the location of various sections of a hospital, e.g., the x-ray department, which the User may need and it can be used to remind the User of doctor's appointments which can be pre-set via voice application in DCP device command. The DCP device is further constructed to be worn in an aged care facility and can help the User and facility staff by allowing the User to perform his/her own tasks. Similarly, the DCP device could used as a assessment feature/tool for the User in place of a person being assessed by a facilitator especially when the User becomes cagey and try to prove they are still 100% okay when the User realizes that they are faltering mentally or physically and may try to hide this fact from facility staff. The assessment feature/tool could assess a User's mental or physical competence level for staff doctors or specialists without the awareness of same by the User

The DCP device is further constructed to be water resistant so they a User may wear it in the shower via a wrist bracelet, wrist watch band, earpiece, lanyard, or necklace and is further provided with a GPS tracking component to determine if the User has wondered away from his/her usual abode or may be in an unsafe area. Additionally, the DCP device can assist in crime protection preventing the User from becoming an “easy target” for criminals.

The DCP device is also provided with an illumination feature, solar panel and/or battery re-charging appliance and is capable being recharged by indoor lighting as well as outdoor lighting. The DCP device is further provided with a battery backup and is also provided with an alarm component which can be in the form of a sounder and/or vibrator capable of communicating with the User by skin. The alarm component is further capable of alerting the User of instant messages as the capacity of the User diminishes. The vibrator can be in the form of a feeler sensor.

The DCP device is further provided with a voice activation component and/or a picture display prompts to be used by a User unable to read. The voice activation component is particularly useful for a visually impaired User and could be in the form of a button, a refreshable braille computer display or braille terminal or other touch feature capable of change settings.

### BRIEF DESCRIPTION OF THE DRAWINGS

FIG. 1 discloses a first embodiment of the DCP device 2.

FIG. 2 is a detailed figure of the DCP device 2 and its operation with either a mobile electronic tablet and/or a mobile electronic smart phone device.

FIG. 3 is a detailed figure of the DCP device of FIGS. 1 and 2 showing other features of DCP device 2.

FIG. 4 is a detailed figure of the DCP device 2 of FIGS. 1-3 disclosing its microchip and power source.

FIG. 5 discloses a second embodiment of the DCP device.

FIG. 6 shows details of the DCP device of FIG. 5.

FIG. 7 shows further details of the DCP device of FIG. 5.

FIG. 8 shows further details of the DCP device of FIG. 5

FIG. 9 shows a third embodiment of the DCP device.

FIG. 10 is a task flow chart showing how the DCP device and system function to perform its operation.

FIG. 11 is a step by step flow chart of an example of various task routines to be prompted by the DCP device and system.

### DETAILED DESCRIPTION OF THE INVENTION

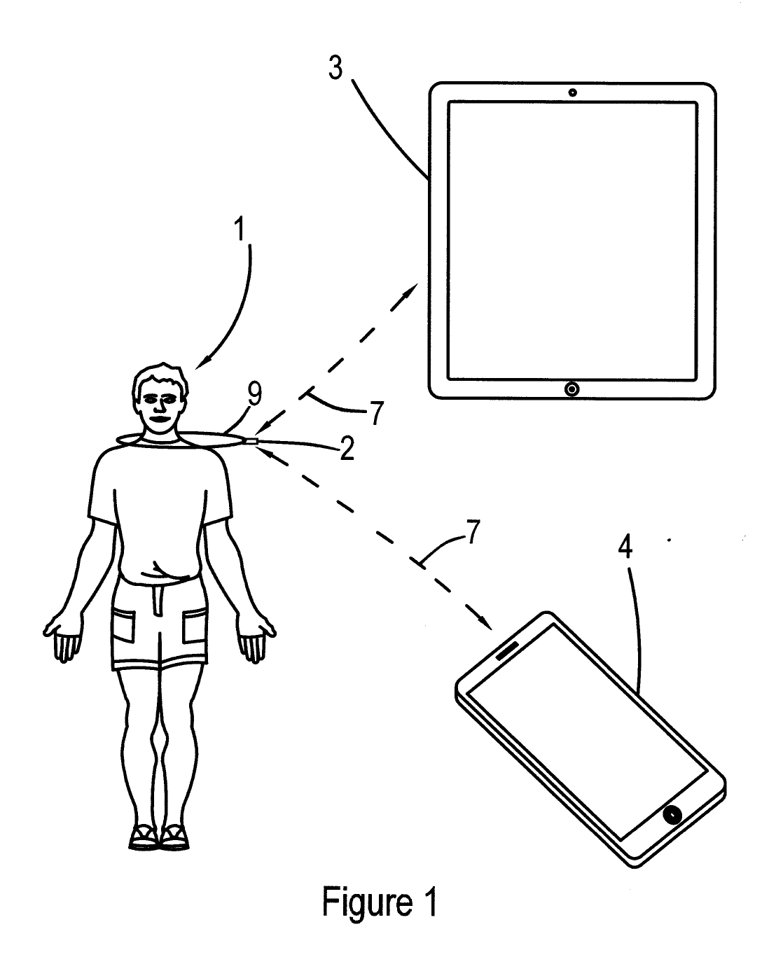

FIG. 1 shows a first embodiment of the DCP device 2 being utilized by a User 1, in the form of a lanyard or necklace 9. DCP device 2 is shown being attached to lanyard or necklace 9 and is capable of electronically communicating, by wireless signals 7, as is disclosed and discussed below, with an electronic appliance in the form of an electronic tablet 3 and/or smart phone device 4.

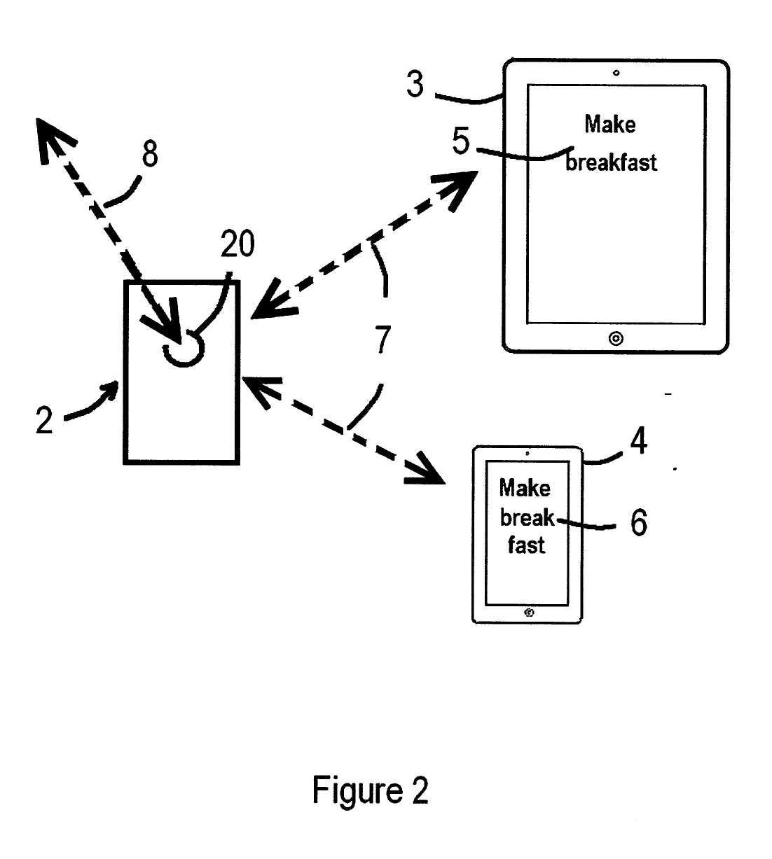

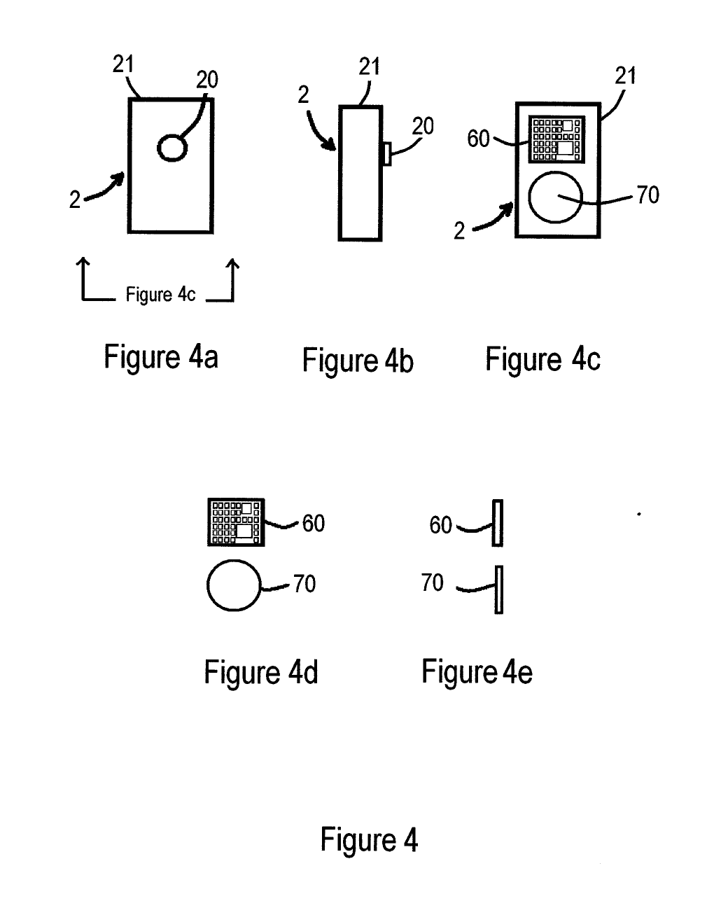

FIG. 2 discloses furthers the operation of the DCP device 2. Particularly, FIG. 2 shows that DCP device 2 is provided with a button 20 which can be depressed by a User; button 20 can be used either for emergencies or can be used to activate a set of commands pre-set by the User. Additionally the DCP device is capable of creating and transmitting electronic signals, via a wireless signal transmitter imbedded in the DCP device in the form of a micro-chip transmitter sensor device 60, further disclosed and discussed in reference to FIG. 4. Upon activation, microcomputer sensor transmitter processor 60 sends a wireless signal 7, by various systems, such as a technology that allows electronic devices to a network, i.e., WI-FI, or a wireless technology standard for exchanging data over short distances commonly known as Bluetooth, or ZigBee, etc. Additionally, wireless signal 7 can be transmitted to an emergency alert system such medical alert staff desk, nursing station or emergency office or facility. The wireless signal 7 is also transmittable to a mobile electronic appliance, such as a smart phone 4, or an electronic tablet 3. The mobile electronic appliance, either electronic tablet 3 or smart phone 4 is capable of sending, receiving, and processing the wireless signals and/or data and also is compatible with the Android mobile operating system, the Iphone cellular phone mobile operating system, i.e., Ios, and other commercially available mobile device operating systems. Additionally, the microcomputer sensor transmitter device processor 60 incorporates radiofrequency microchip technology, discussed further in reference to FIG. 4, capable of sending, receiving, processing, and transmitting data and/or signals 8 to and from navigational positioning systems, such as the Global Positioning System, i.e., GPS, or Global Navigational Satellite System, i.e., the GLONASS. Microcomputer transmitter processor 60 is further capable of being coded with information regarding the identity of the User such as his or her birth date, owner, home location, medical records, etc. Additionally, the sensor transmitter device 60 is capable of creating a signal and/or data which can be transmitted to a satellite navigational technology system, i.e., GPS or GLONASS, for geographically locating the sensor transmitter device which signals and/or data can transmit signals and/or data to the mobile electronic appliance.

As is further shown in FIG. 2, the mobile electronic appliance, either electronic tablet 3 or smart phone 4, is provided with or is accessible to computer processing application software, i.e., otherwise known as an “app”, which app is capable of processing any signal and/or data received by the sensor device. For the electronic tablet 3, this app is shown as reference number 5 while for the smart phone 4, the app is shown as reference number 6. Additionally, apps 5 and 6 are capable of producing display or command prompts, in the example of FIG. 2, the command “Make Breakfast” to inform, remind or command the User to perform a certain task. Although DCP device 2 is disclosed, as is discussed in reference to FIG. 4, as being powered by a battery, the device is configured to be allowed to be powered with solar energy.

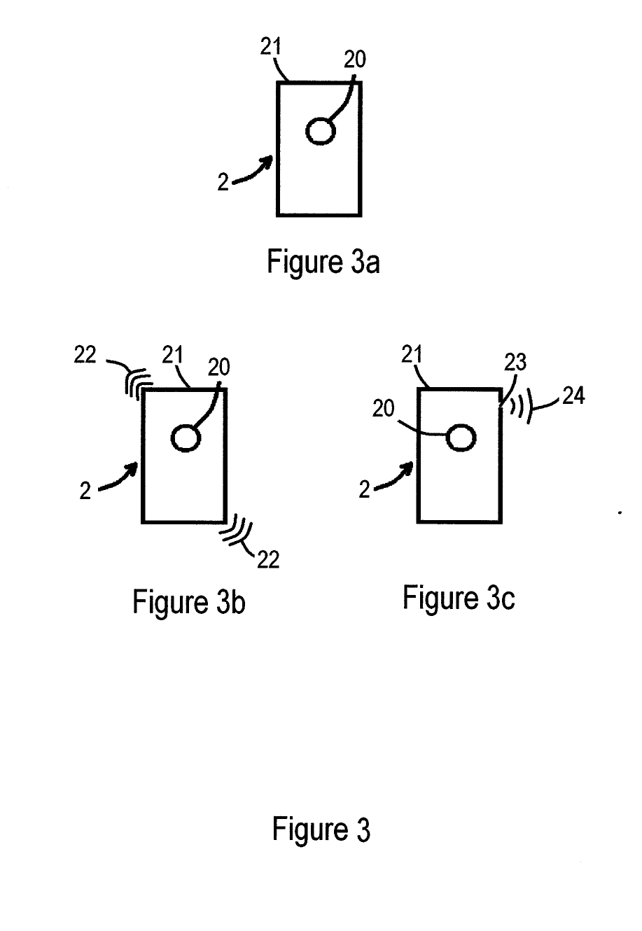

FIG. 3 reveals additional features of DCP device 2. Particularly FIG. 3a shows the overall construction of DCP device 2 having a body 21 and emergency activation button 20 while FIG. 3b reveals the vibration feature 22 of DCP device 2 allowing the device to act in an alarm or awakening mode. FIG. 3c reveals a transceiver 23 provided with DCP device 2 capable of producing alarm or awakening sound 24. Transceiver 23 is also capable of receiving voice commands or input.

FIG. 4 is a detailed figure of DCP device 2 showing details of the device construction. Particularly, FIG. 4a discloses that DCP device 2 has a body 21 and emergency activation button 20. FIG. 4b is a side view of FIG. 4a showing DCP device 2 in profile. FIG. 4c is a cross-sectional view of FIG. 4a showing internal operational components of DCP device 2, particularly microcomputer sensor/transmitter processor 60 and power source 70 in the form of a disc battery. FIG. 4d shows the microcomputer sensor/transmitter processor 60 and power source 70 individually revealing their relative size while FIG. 4e is a side profile view of microcomputer sensor/transmitter 60 and power source 70. As previously discussed, microcomputer sensor/transmitter processor 60 is capable of being coded with information regarding the identity of the User and is capable of creating and receiving signals and/or data which can be transmitted to a satellite navigational technology system. Microchip sensor/transmitter 60 also can transmit and receive signals and/or data to the mobile electronic appliance, electronic tablet 3 or smart phone 5.

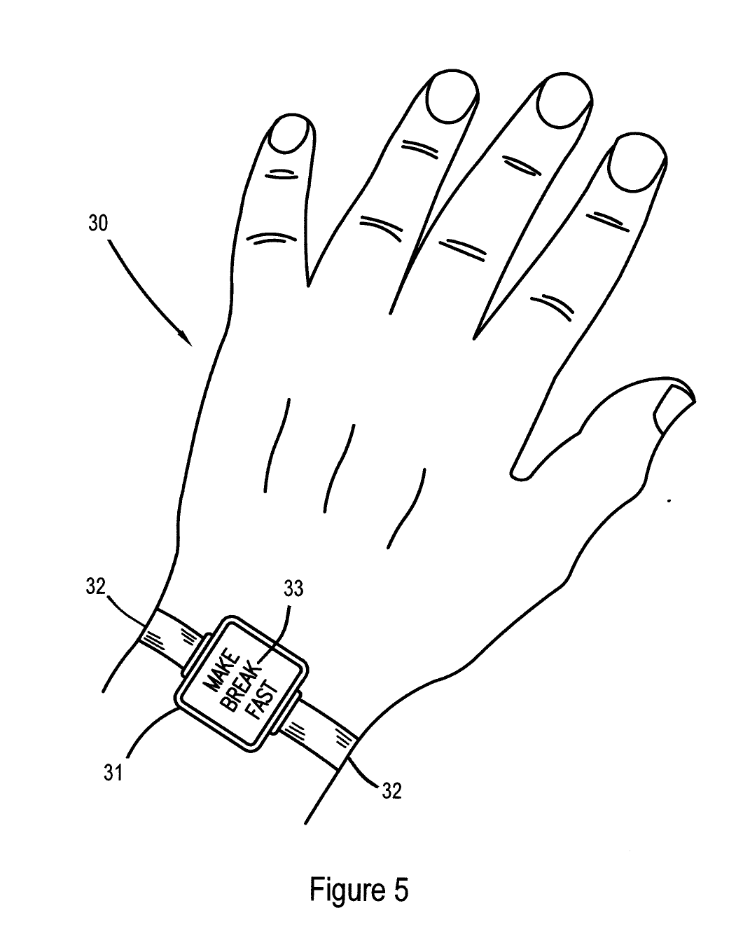

FIG. 5 discloses a second embodiment of the DCP device. Particularly, FIG. 5 discloses a DCP device 31 housed in the form of watch, having watchband 32, being worn on a hand 30 of the User 1. Additionally, as FIG. 5 discloses, DCP device 31 has a visual screen display 33, via a computer application program, imbedded in the device similar to that of DCP device 2 electronic tablet 3 app 5 and/or smart phone 4 app 6, capable of communicating a command message or prompt to the User 1, here as example “Make Breakfast”. DCP device 31 is configured to be touch activated on its screen although it can be activated by traditional buttons. Additionally, DCP device 31 has an illumination display feature allowing the device to be seen at night or in low-light environments.

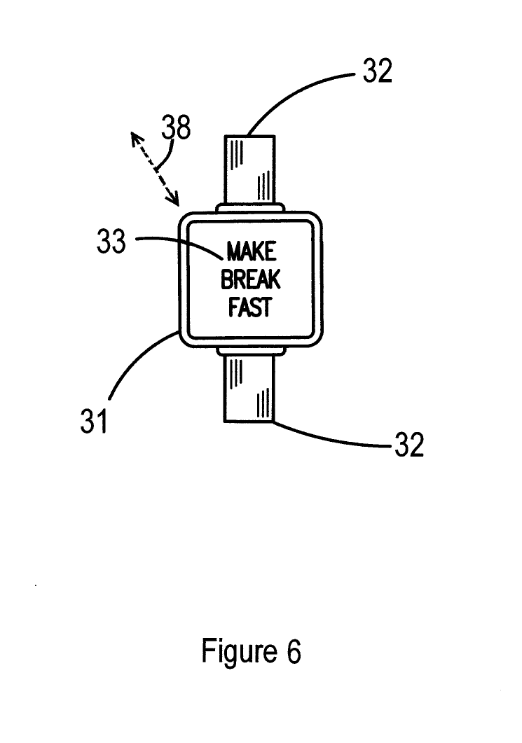

FIG. 6 shows details of the DCP device 31 with wristband 32, particularly wireless communication signal feature producing and receiving electronic signals 38. DCP device 31, is internally provided with electronic components similar to microcomputer sensor/transmitter processor 60 and power source 70 of DCP device 2. As such, DCP device 31 is capable of electronically communicating with GPS and GLONASS satellite systems for allowing location of wearer of the device, i.e., the User.

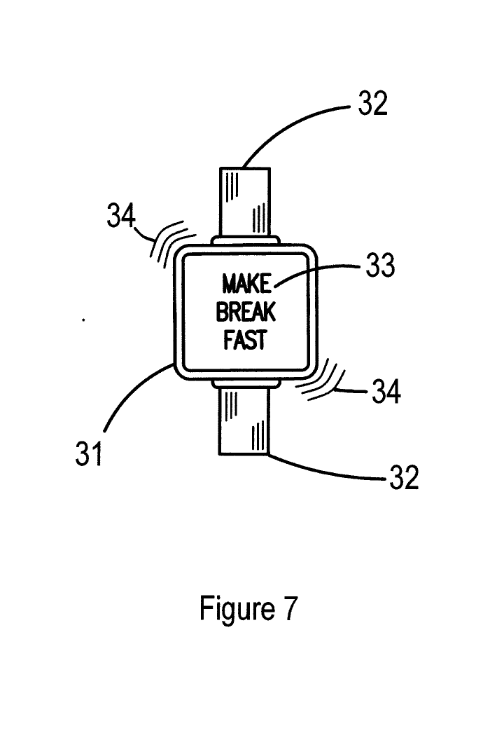

FIG. 7 discloses an additional feature of DCP device 31, particularly, a vibration capability allowing the device to awaken, remind and or alert the User to perform a particular task, here, as an example, to “Make Breakfast”.

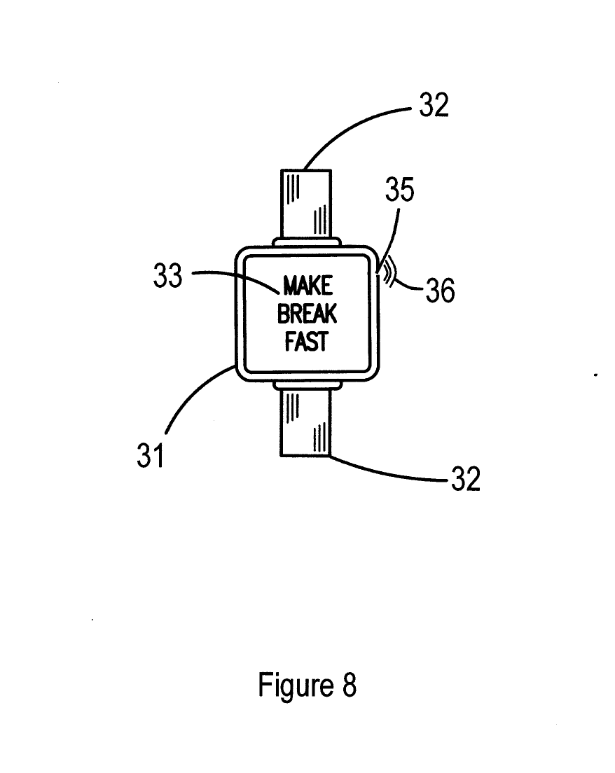

FIG. 8 discloses an additional feature of the DCP device 31, particularly, a sound transceiver 5 capable of emitting sound 36 for alerting the User to awaken, remind and or alert the User to perform a particular task, here, as an example, to “Make Breakfast”. Additionally, transceiver 35 is capable of receiving audible input which can be used to program DCP device 31.

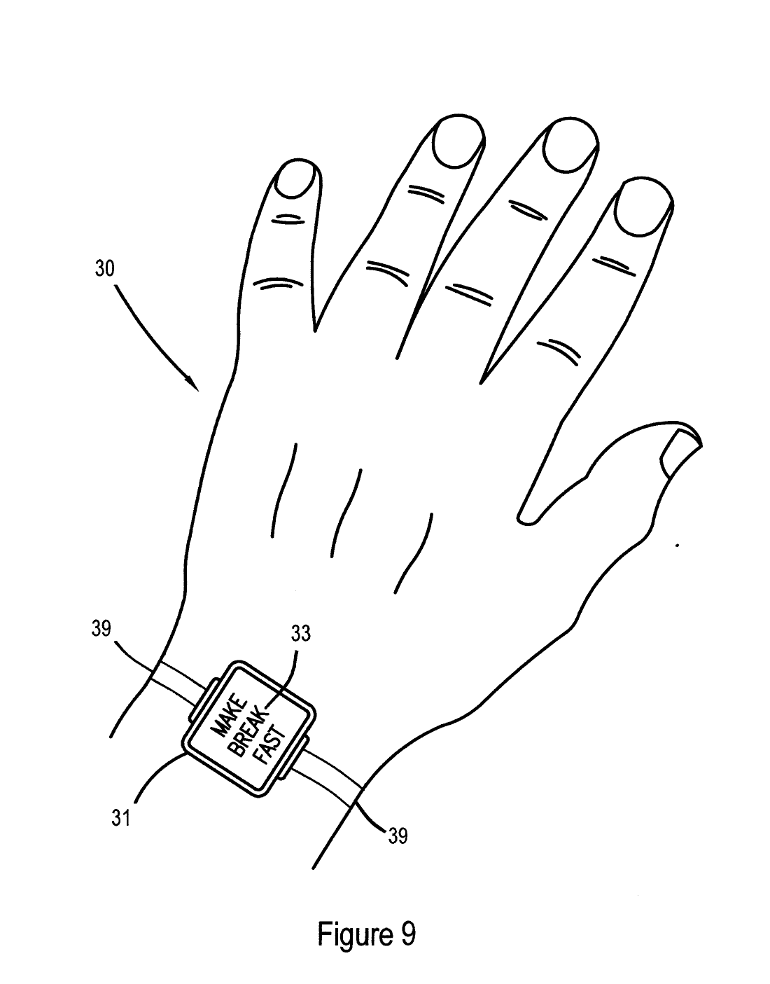

FIG. 9 shows an third embodiment of the DCP device 31 being utilized by a User 1, consisting of a bracelet type device 39 for securing DCP device 31 on a hand 30 of the User 1, such that the DCP device has a visual display capable of communicating a command message to the User. The DCP device 31 of FIG. 9 has all of the features and capabilities of the DCP device 31 of FIGS. 5-8.

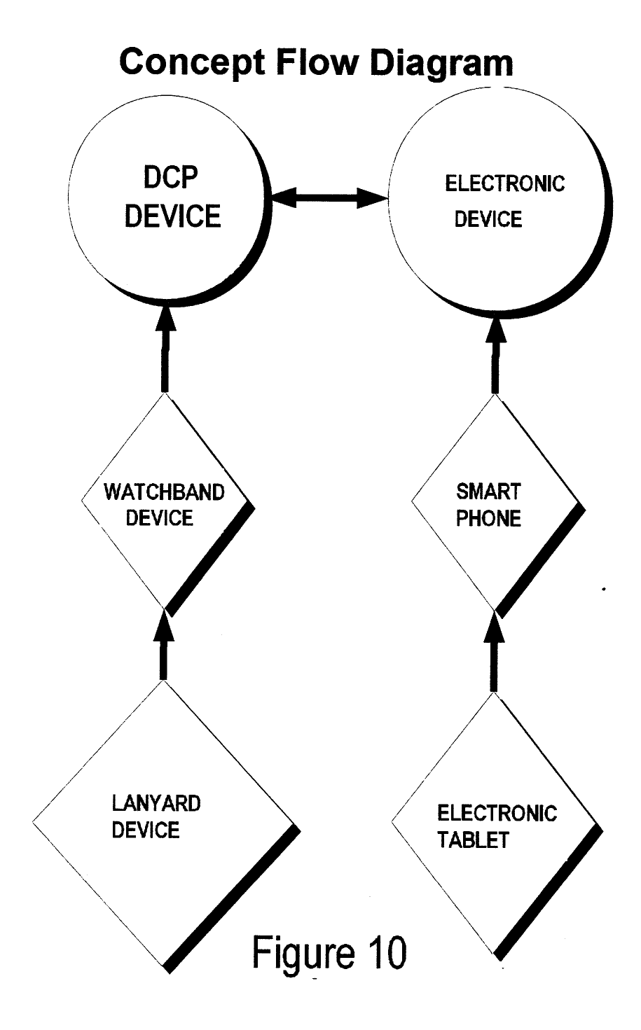

Now referring to FIG. 10, a concept flow diagram of the system according to the preferred embodiment of the invention is shown. Particularly in FIG. 10, the overall operation of the preferred embodiment of the invention is disclosed wherein the DCP device, denoted by the encircled term device may comprise wrist watchband, bracelet, lanyard attachment, etc. As FIG. 10 furthers discloses, the DCP device and system, whether it is the embodiment of FIG. 1, 5 or 9, of the instant invention is provided with a sensor device capable of creating and transmitting electronic signals, via a wireless signal transmitter imbedded in the sensor device. The wireless signals are transmittable to a mobile electronic appliance, such as a smart phone, or an electronic tablet. The mobile electronic appliance is capable of sending, receiving, and processing the wireless signals and/or data and also is compatible with the Android mobile operating system, the Iphone cellular phone mobile operating system, i.e., Ios, and other commercially available mobile device operating systems. Additionally, the sensor device of the invention incorporates radiofrequency microchip technology, in the form of a microcomputer transmitter processor capable of sending, receiving, processing, and transmitting data and/or signals to and from navigational positioning systems, such as the Global Positioning System for locating the sensor devices which signals and/or data can transmit signals and/or data to the mobile electronic appliance. As is further shown in FIG. 10, the mobile electronic appliance is provided with or is accessible to computer processing application software, i.e., otherwise known as an app, which app is capable of processing the any signal and/or data receiving by the sensor device.

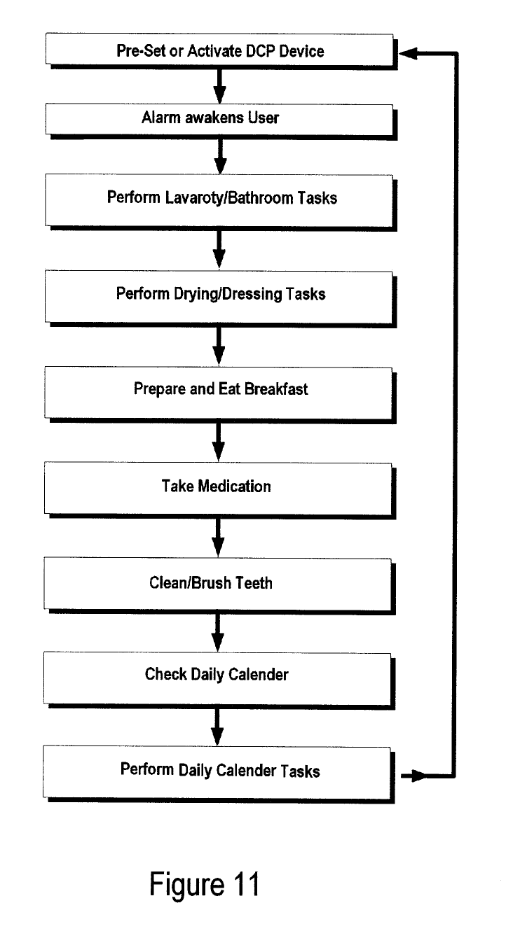

FIG. 11 a step by step flow chart of an example of various task routines to be prompted by the DCP device and system. Particularly in FIG. 11 is shown that the DCP device would be Preset or Activated by a User resulting in an alarm awakening the User for a morning routine. The DCP device would then prompt the User to perform lavatory or bathroom tasks followed by drying and dressing tasks. Next the User would be prompted to prepare, i.e., prompt “Make Breakfast”, and eat breakfast after which he/she would be prompted to take required medication. Subsequently, the User would be prompted to clean and brush their teeth and then to check their daily calendar to remind or prompt them as to perform tasks required for that day. Once all the daily tasks, the User would be prompted to pre-set and/or activate the DCP device for the next day.

The following example of how the DCP device can be utilized for a typical User's morning routine is described. The DCP device is pre-set by selecting initial operation, by example an alarm for the User to awaken. The alarm may sound out loud on alarm set or may be by vibration though feeling on the skin. e.g. vibration through contact, to start the beginning of the day in regard to routine and what is a suitable time for their day to commence, e.g. 8 am. This alarm at Sam would activate such that the User can hear various commands as to get up out of bed, by greeting them firstly with the time of day and the date. Additionally, the DCP device could have a temperature guide, as to weather conditions outside, to assist and instruct the User for daily selection of clothing required to be worn for the day ahead, it would then suggest to them the clothing articles to select. The DCP device would then instruct or assist the User with daily lavatory bathroom routines and then continue with shower or bathing reminders, such as washing and conditioning hair, shaving for men, applying body location for women. Subsequently, a prompt or command for drying and dressing following by the preparation for breakfast giving only a few selections, minimize confusion of choice. Depending on the individual, the breakfast, choices could alter daily depending on the User habits and could include prior to breakfast, e.g. cup of tea, toast with jam. Then while during breakfast preparation, a time slot for medication could be allowed, for example medication to be taken from a Webster-pak™, i.e., packets of medication pre-sealed at pharmacies available in Australia and other parts of the World. The Webster-pak™ could be pre-filled from pharmacy or prescription bottles and the DCP device could prompt the User what is to be administered for their needs if it was to be taken with breakfast for example. After breakfast and a prompted clean up, the User would be prompted to clean their teeth. Next the DCP device would give the User a read out of what was on the calendar for the day, which could be reinforced with daily check list e.g. 1) taxi pick up/community car 10 am; 2) doctor or specialist appointment., 3) community groups, 4) Probus meetings i.e., a club organization, popular in Australia and the United Kingdom consisting of local associations of retired and semi-retired professional and business people organized to pursue any field or activity of worthy endeavor, 5) Community Care, 6) Exercise—walking group, etc. Although this example describes the use of a DCP device for a morning routine, it is to be understood, that the DCP device can also be programmed for afternoon, evening and night routines.

When introducing elements of the present invention or the preferred embodiment(s) thereof, the articles “a”, “an”, “the”, and “said” are intended to mean there are one or more of the elements. The terms “comprising”, “including”, and “having” are intended to be inclusive and mean that there may be additional elements other than the listed elements. Additionally, any description of the exemplary or preferred embodiments is intended to be read in connection with the accompanying drawings, which are to be considered part of the entire written description.

Additionally, the principles of the invention could be practiced by those of skilled in the art with equivalent alternative constructions. Although the present invention has been described in considerable detail with reference to a certain preferred embodiment thereof, other embodiments are possible. Therefore, the spirit and scope of the appended claims should not be limited to the description of the preferred embodiment(s) contained herein. The invention may be embodied and practiced in other specific forms without departing from the spirit and essential characteristics thereof. The present embodiments are therefore to be considered in all respects as illustrative and not restrictive, the scope of the invention being indicated by the appended claims rather than by the foregoing description; and all variations, substitutions and changes which come within the meaning and range of equivalency of the claims are therefore intended to be embraced therein.

What is claimed:

1. A wearable digital command prompting device to assist people in daily tasks for use by a user comprising
means for electronically communicating said device with an electronic appliance and wherein the device can be activated by the user and further wherein the device is provided with
means capable of sending and receiving electronic signals to an emergency alert system and further wherein the device is provided with
means to produce a wireless signal which is transmittable to a mobile electronic appliance and further wherein said electronic appliance is provided with a computer processing application software which is capable of processing any signal received by the device and further wherein the computer processing application software is capable of producing display or command prompts on the electronic appliance to inform, remind or command the User to perform a certain task.

2. The wearable digital command prompting device of claim 1 further provided with means for transmitting to and receiving a wireless signal from a navigational positioning system.

3. The wearable digital command prompting device of claim 2 further provided with means in the form of push button for activating the device by the user.

4. The wearable digital command prompting device of claim 3 further provided with means for causing the device to vibrate.

5. The wearable digital command prompting device of claim 5 further provided with means for causing the device to produce sounds or to receive voice commands or input.

6. The wearable digital command prompting device of claim 5 further provided with a microcomputer sensor/transmitter processor.

7. The wearable digital command prompting device of claim 6 further provided with a power source.

8. The wearable digital command prompting device of claim 7 further provided with a lanyard to allow the user to wear the device.

9. The wearable digital command prompting device of claim 2 wherein the device is housed in a watch.

10. The wearable digital command prompting device of claim 9 further provided with means for causing the device to vibrate.

11. The wearable digital command prompting device of claim 10 further provided with means for causing the device to produce sounds or to receive voice commands or input.

12. The wearable digital command prompting device of claim 11 further provided with a watchband.

13. The wearable digital command prompting device of claim 12 further provided with a bracelet.

14. The wearable digital command prompting device of claim 1 wherein the appliance comprises an electronic tablet.

15. The wearable digital command prompting device of claim 1 wherein the appliance comprises a smart phone.

16. A wearable digital command prompting device for use by a user comprising a lanyard or necklace and wherein
the lanyard or necklace is provided with the device is capable of electronically communicating, by wireless signals, with an electronic appliance in the form of an electronic tablet and/or smart phone device and wherein
the device is provided with an emergency button which can be activated by the user and wherein
the device is capable of creating and transmitting electronic signals, via a wireless signal transmitter imbedded in the device in the form of a microcomputer transmitter/sensor processor and further wherein upon activation of emergency button the microcomputer sensor transmitter processor sends a wireless signal by either a wireless technology standard for exchanging data over short distances and further wherein the wireless signal can be transmitted to an emergency alert system such medical alert staff desk, nursing station or emergency office or facility and further wherein the wireless signal is transmittable to a mobile electronic appliance either in the form of a smart phone, or an electronic tablet and further wherein the electronic tablet or smart phone is capable of sending, receiving, and processing the wireless signal and is compatible the Android mobile operating system and/or the Iphone cellular phone mobile operating system known as Ios and further wherein
the microcomputer sensor transmitter processor is capable of sending, receiving, processing, and transmitting data and/or signals to and from navigational positioning systems such as the Global Positioning System, i.e., GPS, or Global Navigational Satellite System, i.e., the GLONASS for geographically locating the User and further wherein the electronic tablet or smart phone, is provided with or is accessible to computer processing application software which is capable of processing a signal data received by the device and further wherein
the computer processing application software is capable of producing display or command prompts to inform, remind or command the User to perform a certain task and further wherein
the device is powered by a battery and further wherein
the device is provided with means for causing the device to vibrate to act in an alarm or awakening mode and further wherein
the device is provided with means for causing the device to produce sounds or to receive voice commands or input voice commands to inform, remind or command the user to perform a certain task.

17. A wearable digital command prompting device for use by a user comprising
a watchband to be worn by the user wherein the device is provided with a visual display produced by a computer application program software imbedded in a microcomputer sensor/transmitter processor in the device wherein the visual display consisting of a command message or prompt to inform, remind or command the user to perform a certain task and further wherein the microcomputer sensor/transmitter processor is capable of sending, receiving, processing, and transmitting a signal to and from navigational positioning systems such as the Global Positioning System, i.e., GPS, or Global Navigational Satellite System, i.e., the GLONASS for geographically locating the User and further wherein the computer processing application software which is capable of processing a signal received by the device and further wherein the computer processing application software is capable of producing display or command prompts to inform, remind or command the User to perform a certain task and further wherein
the device is powered by a battery and further wherein the device is provided with means to cause the device to vibrate to act in an alarm or awakening mode and further wherein the device is provided means for causing the device to produce sounds or to receive voice commands or input voice commands to inform, remind or command the user to perform a certain task.
